(19) United States
(12) Patent Application Publication
(10) Pub. No.: US 2011/0297183 A1
(43) Pub. Date: Dec. 8, 2011

(54) ACTIVE BARRIER TO FOREIGN PARTICLE DEPOSITION ON A DEVICE SURFACE VIA VIBRATIONS

(75) Inventor: Gordon Cameron, Sunnyvale, CA (US)

(73) Assignee: APPLE INC., Cupertino, CA (US)

(21) Appl. No.: 13/109,830

(22) Filed: May 17, 2011

Related U.S. Application Data
(60) Provisional application No. 61/352,232, filed on Jun. 7, 2010.

(51) Int. Cl. B08B 3/12

(52) U.S. Cl. 134/1; 134/56 R

(57) ABSTRACT

To prevent foreign particles from adhering to an external surface of an electronic device and adversely affecting a user's enjoyment of the device, and to remove adhered foreign particles, a source of mechanical waves can be incorporated within the device. The source can provide mechanical waves tuned to prevent foreign particles from adhering, or to remove foreign particles adhered to the external surface of the device, for example by increasing the contact angle between the foreign particles and the outer component. In some cases, the electronic device can dynamically tune, modify, or adjust emitted waves to direct foreign particles towards particular regions of the device, or to provide waves better adapted at removing different types of particles. In some embodiments, the electronic device can include a reservoir for receiving and holding foreign particles until they are removed from the device.

### CROSS-REFERENCE TO RELATED APPLICATION

This application claims the benefit of previously filed U.S. Provisional Patent Application No. 61/352,232, filed on Jun. 7, 2010, entitled “ACTIVE BARRIER TO FOREIGN PARTICLE DEPOSITION ON A DEVICE SURFACE VIA VIBRATIONS,” which is incorporated herein in its entirety.

### BACKGROUND

Electronic devices can include external surfaces that a user can touch. A user's finger can include natural oils, grime, water, or other foreign particles that can be accumulated over time. When the user touches the device, the foreign particles of the user's finger can be deposited on the external surface of the device and may leave marks. In particular, the deposited materials can change the manner in which light is reflected from the external surface, and may prevent a user from properly seeing through some external surfaces (e.g., seeing through a glass component), or limit the aesthetic appeal of the device.

Different approaches have been used to attempt to reduce the number of foreign particles that adhere to an external surface, or to remove foreign particles from the external surface. For example, some external surfaces are formed from a material having properties that prevent the deposition or adhesion of particles to the material, or that reduce the visibility of foreign particles when they adhere to the material (e.g., a plastic material). As another example, passive coatings can be applied to an external surface to prevent the deposition of foreign particles (e.g., an oleophobic coating).

In some cases, however, a material selected for an external surface can be particularly attractive to foreign particles. In particular, a material selected for its aesthetic appeal (e.g., based on industrial design considerations) may also allow a relatively easy adhesion of foreign particles to the material surface. Furthermore, the material selected may have surface properties that prevent the application of a preventive coating on the material. One such material can include, for example, 304 stainless steel. When an external surface of an electronic device is constructed with such materials, passive approaches may not be as easily available to prevent the deposition of foreign particles on the surface.

### SUMMARY OF THE INVENTION

This is directed to an active barrier for use with an electronic device. The active barrier can prevent or reduce the deposition of foreign particles on an external surface of an electronic device, or can assist in the removal of foreign particles adhered to the external surface of the electronic device. In particular, this is directed to disposing wave sources within an electronic device operative to emit waves directed towards a surface of an outer component.

External surfaces of a device can include surfaces of outer components such as, for example, surfaces of enclosures, outer shells, housings, bezels, bands, display components (e.g., cover glass), or other such components. An outer component can be constructed from a material to which a passive barrier or coating preventing the deposition of foreign particles cannot be applied. To prevent or reduce the ability of foreign particles from adhering to the external surface and adversely affecting a user's enjoyment of the device, or to remove foreign particles that have adhered to the external surface, a source of mechanical waves can be incorporated within the device, for example near the outer component. The source of mechanical waves can include, for example, a voice coil or a piezo-electric component.

The provided mechanical waves propagate along the surface of the outer component towards the location of a foreign particle to change the characteristics of the surface. This may serve to both prevent foreign particles from adhering to the surface, and to assist in the removal of foreign particles already adhered to the surface. In particular, the mechanical waves can change the characteristics of the surface of the outer component to prevent a foreign particle from wetting the surface. In addition, if the foreign particle has wet the surface (e.g., because no waves were provided when the particle came into contact with the surface), the mechanical waves can cause the wetting angle of the foreign particle to increase by changing the characteristics of the surface, which may facilitate the removal of the foreign particle.

In some embodiments, the generated waves can be dynamically adjusted or tuned. For example, a wave can be adjusted based on a location on the outer component of a particular foreign particle. As another example, a wave can be adjusted based on the type of foreign particle, or on the type of bond between the foreign particle and the outer component. As still another example, the wave can be dynamically adjusted to prevent a user from feeling the wave when the user holds the outer component. In particular, the wave can have a particular waveform, amplitude, and frequency in the vicinity of the user's finger or hand, such that the wave is not or only lightly detectable by the user.

As discussed above, some foreign particles may nevertheless adhere to external surfaces of a device. To assist in the removal of the foreign particles, the wave source can, in some cases, emit a wave for directing foreign particles away from the center of the outer component and towards external boundaries of the device (e.g., towards a periphery of the device). In some cases, the outer component (or the device as a whole) can include one or more collection regions, or one or more wicks into which foreign particles can collect. When the collection regions fill, a user can empty the collection regions to allow additional foreign particles to be directed toward the collection regions. In some cases, the collection regions or wicks can be disposed such that the act of putting a device in a pocket or bag can be sufficient to empty the region and remove foreign particles adhered to the outer component.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a sectional view of an illustrative electronic device having an active foreign particle barrier in accordance with some embodiments of the invention;

FIGS. 2A and 2B are schematic views of a user's finger as it detects movement in accordance with some embodiments of the invention;

FIG. 3 is a schematic view of an illustrative particle adhered to a surface of an outer component by a low contact angle in accordance with some embodiments of the invention;

FIG. 4 is a schematic view of an illustrative particle adhered to a surface of an outer component with a high contact angle in accordance with some embodiments of the invention;

FIG. 5 is a schematic view of a portion of an illustrative electronic device enclosure having wave sources in accordance with some embodiments of the invention;

FIG. 6 is a sectional view of an illustrative reservoir for receiving foreign particles in accordance with some embodiments of the invention;

FIG. 7 is a flowchart of an illustrative process for removing foreign particles adhered to an outer component of a device in accordance with some embodiments of the invention; and

FIG. 8 is a flowchart of an illustrative process for directing a foreign particle towards a reservoir in accordance with some embodiments of the invention.

### DETAILED DESCRIPTION

An electronic device can include an active barrier preventing or reducing the adhesion of foreign particles on an external surface of the device, and for removing foreign particles that have been deposited on the external surface of the device.

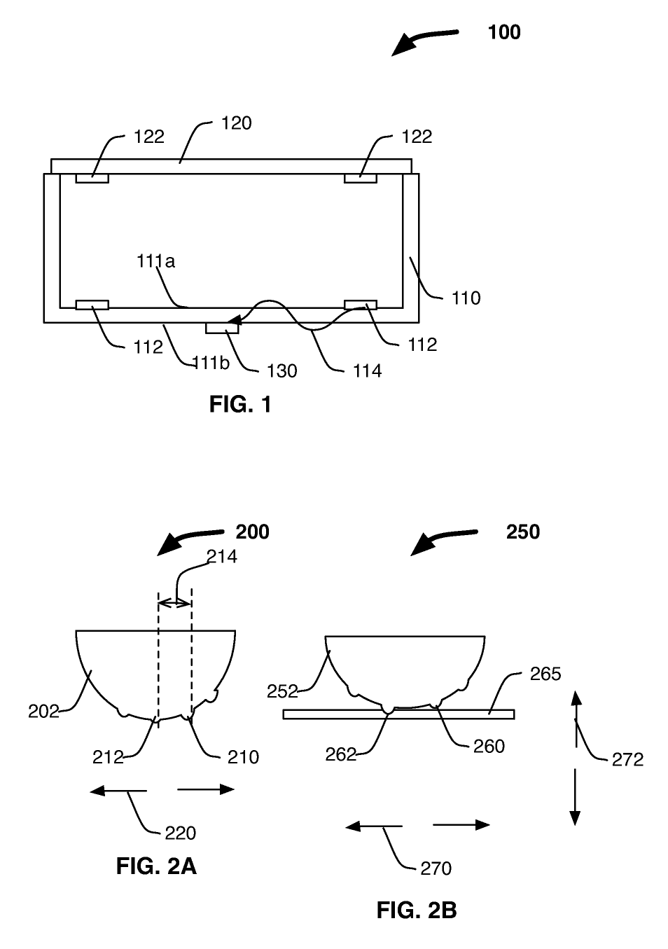

FIG. 1 is a sectional view of an illustrative electronic device having an active foreign particle barrier in accordance with some embodiments of the invention. Electronic device 100 can include any suitable type of electronic device. For example, electronic device 100 can include a media player such as an iPod® available by Apple Inc., of Cupertino, Calif., a cellular telephone, a personal e-mail or messaging device (e.g., a Blackberry®), an iPhone® available from Apple Inc., pocket-sized personal computers, personal digital assistants (PDAs), a tablet or slate type device such as an iPad® available from Apple Inc., a laptop computer, a music recorder, a video recorder, a gaming device, a camera, radios, medical equipment, or any other portable electronic device with which a user can interact. In some embodiments, embodiments described herein can in addition be applied to components or objects other than electronic devices for forming an active barrier to foreign particles.

The outer enclosure of electronic device 100 can be constructed by combining several distinct outer components or elements to enclose a volume in which device components can be secured. Although the following discussion will describe an active barrier in the context of an enclosure, it will be understood that embodiments described can also be applied to individual outer components. In the example of device 100, the enclosure can include housing 110 and display 120, where the housing and display are constructed from the same or different materials. In particular, housing 110 can be constructed from a metal (e.g., 304 stainless steel), while display 120 can be constructed from glass. The one or more materials selected for the outer components of the enclosure can be more or less susceptible to having foreign contaminants adhere to the surfaces of the components. In particular, glass and 304 stainless steel can be oleophilic and gather oils and other particles from a user's fingers or hand as the user uses the device.

The electronic device can include any suitable component providing an active barrier to the adherence of foreign particles on an enclosure surface. In some embodiments, electronic device 100 can include one or more wave sources 112 placed in the vicinity of housing 110, and one or more wave sources 122 placed in the vicinity of display 120. The wave sources can be controlled, for example, by a processor or control circuitry. Any suitable type of wave source can be used including, for example, a voice coil (e.g., providing acoustic waves) or a piezo-electric component (e.g., providing vibrations). The wave sources can be disposed in any suitable configuration on the device enclosure including, for example, in a regular pattern, in a pattern selected based on expected locations at which foreign particles will come into contact with the enclosure, in an arbitrary distribution, based on available space within the device, or combinations of these. In some embodiments, the characteristics of waves provided by each of the wave sources can vary so that waves provided by different sources can combine or be offset to provide different levels of wave energy in different regions of the enclosure.

The wave sources can be disposed such that waves generated by the sources can propagate towards external surfaces of the enclosure. In some embodiments, the wave sources can be disposed in contact with an inner surface of an outer component such that generated waves can propagate through the thickness or body of the outer component and towards an external surface of the outer component. For example, wave 114 generated by wave source 112 can propagate through housing 110 from inner surface 111a towards outer surface 111b, to which particle 130 is adhered. In some cases, several wave sources 112 or wave sources 122 can provide waves that propagate towards particle 130.

A wave generated by a wave source used in electronic device 100 can have any suitable form. For example, an audio wave can be provided. In such cases, it may be desirable to provide a wave at a frequency that is outside of a user's hearing range so that the user does not hear an audible sound from the wave source (e.g., an ultrasound wave). Alternatively, the wave source can provide a sound wave that falls within an audible frequency range, but the wave source can be combined with a secondary element that masks or interferes with the sound wave to that the user cannot hear the sound wave. In particular, a secondary wave source can provide an interfering wave that eliminates the sound wave once it reaches the enclosure surface where the foreign particles are found, but after the sound wave acts to detach the particles from the enclosure.

In some embodiments, a wave can be provided in the form of vibrations of the device. For example, the wave source can cause vibrations in an outer component at a particular frequency or amplitude. Any approach can be used to reduce or eliminate a user's ability to detect the vibrations. For example, the vibrations can be tuned to create displacements along an orientation less detectable by a user's finger. FIGS. 2A and 2B are schematic views of a user's finger as it detects movement in accordance with some embodiments of the invention. Finger 200, shown in FIG. 2A, can include at least distinct ridges 210 and 212 extending from external surface 202 of the finger. When a user's finger is not in contact with a surface, or when no vibrations or other forces are applied to the user's finger, the ridges can be spaced apart by a default or at-rest distance 214 along axis 220 (e.g., substantially tangent to surface 202). When ridges 210 and 212 are thus spaced apart, a user may feel that the finger is not in contact with any surface.

Finger 250, shown in FIG. 2B, is placed in contact with surface 265. As the user presses his finger against the surface, the distance between distinct ridges 260 and 262 (e.g., corresponding to ridges 210 and 212, respectively) on external surface 252 of the finger can increase. This movement of ridges along direction 270 can cause a user to feel surface 265. Should surface 265 vibrate or otherwise move, the distance between ridges 260 and 262 can change, which the user would then feel. To prevent the user from feeling a vibration corresponding to the removal of foreign particles from an outer component, vibrations can be tuned so that the vibrations cause a displacement of ridges 260 and 262 along axis 272, perpendicular to surface 265, in the vicinity of the user's finger. By causing a displacement along axis 272 instead of axis 270, which is tangent to or in the plane of surface 265, the distance between ridges 260 and 262 may change by a smaller, and therefore less detectable, amount.

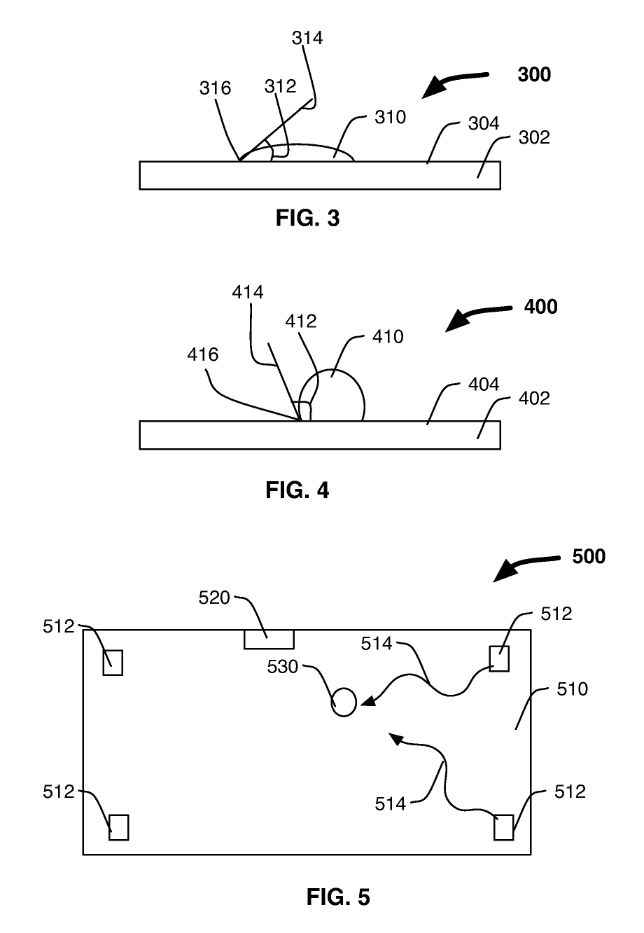

The waves generated by wave sources included within the electronic device enclosure can limit the presence of foreign particles on a device surface using several different mechanisms. By a first mechanism, waves can be used to remove a particle that is already adhered to a surface. Individual foreign particles can bond to a surface using different approaches. In some cases, particles can be substantially fluid or liquid, or include a fluid or liquid component, and adhere to the device surface via wetting. For example, water or oil-based particles can be substantially liquid. FIG. 3 is a schematic view of an illustrative particle adhered to a surface of an outer component by a low wetting or contact angle in accordance with some embodiments of the invention. Portion 300 of an electronic device can include outer component 302 having external surface 304. As the device is uses, particle 310 can come into contact with external surface 304 and wet the surface to bond to outer component 304. Based on the properties of the material and manufacturing processes selected for outer component 302 and the characteristics of particle 310, the particle can wet surface 304 with wetting angle or contact angle 312, where contact angle 312 is defined as the angle between surface 304 and line 314 tangent to particle 310 at contact point 316 between particle 310 and external surface 304. Contact angle 312 can be in the range of near 0 degrees to near 180 degrees. When the contact angle is in the range of 0 to 90 degrees, particle 310 can be considered to have high wettability, and therefore produces a relatively strong bond with external surface 304. To remove the particle, therefore, the contact angle between particle 310 and surface 304 may need to be increased to the range of 90 degrees to 180 degrees, where the bond between the particle and the external surface is weakened. In other words, the interface between external surface 304 and particle 310 may need to be modified such that the particle may have low wettability.

To remove the particle, the active barrier of the device can provide mechanical waves (e.g., sound waves or vibrational waves) that can increase the contact angle of the particle. FIG. 4 is a schematic view of an illustrative particle adhered to a surface of an outer component with a high contact angle in accordance with some embodiments of the invention. Portion 400 of an electronic device can include outer component 402 having external surface 404. When an active barrier is applied to outer component 402 (e.g., mechanical waves are transmitted through outer component 402), the characteristics of external surface 404 can change with respect to wetting. In particular, the waves passing through outer component 404 can create variations in the smoothness of external surface 404, which can cause particle 410 to wet surface 404 with contact angle 412 (e.g., defined as the angle between surface 404 and tangent 414 to particle 410 at contact point 416).

In contrast with contact angle 312 (FIG. 3), which was in the range of 0 degrees to 90 degrees, the waves can cause contact angle 412 to be in the range of 90 degrees to 180 degrees, even though external surface 304 and external surface 404 may be identical other than the presence of waves within outer component 402, and particles 310 and 410 may be identical. The large contact angle 412 reflects low wettability, so that particle 410 can more easily be removed from external surface 404 (e.g., easily wiped away).

By a second mechanism, the active barrier can instead or in addition be used to prevent or reduce the ability of particles from adhering to the enclosure surface with a low contact angle. As discussed above, a particle can wet an external surface of an outer component with a particular contact angle determined from properties of the external surface of the outer component, and properties of the particle. To increase the contact angle with which particles can adhere to the external surface of the outer component, an active barrier can be used to change properties of the external surface of the outer component.

The active barrier can include mechanical waves (e.g., generated by a wave source) that propagate along the external surface of the outer component. The mechanical waves can cause the external surface to be displaced by small amounts (e.g., the external surface vibrates) and in effect become rougher, and can eliminate or reduce smooth and flat regions of the outer component with which foreign particles can come into contact. Because smooth surfaces have a high wettability and rough surfaces have a low wettability, the smoothness or roughness of the external surface can be a substantial factor in determining its wetting properties. As a result, an outer component through which waves propagate may have a low wettability and cause the contact angle of any particle that adheres to the external surface of the outer component to be larger than it would have been had the mechanical waves been absent. This in turn may make it more difficult for foreign particles to wet the external surface with at least a minimal contact angle required for adhesion, or may at least make it easier for the foreign particles to be removed.

In some embodiments, the wave sources can dynamically adjust the generated mechanical waves to control the manner in which particles are removed from surfaces of the device enclosure. FIG. 5 is a schematic view of a portion of an illustrative electronic device enclosure having wave sources in accordance with some embodiments of the invention. Enclosure 500 can include outer component 510 having wave sources 512 disposed in different regions of the enclosure. For example, wave sources 512 can be disposed in different regions of the outer component such that waves emitted by the wave sources can interfere constructively and destructively to provide a particular impulse at any location on outer component 510. Any suitable number of wave sources 512 can be used including, for example, a number in the range of 2 to 10 (e.g., 3 or 4). In the example of outer component 510, wave sources 512 are disposed in different corners of the outer component, though it will be understood that other configurations can be used. In particular, wave sources 512 can be distributed in a particular pattern, as an arbitrary distribution, or in a distribution that targets specific regions of outer component 510 (e.g., regions where foreign particles are most likely to be deposited).

Wave sources 512 can all be the same or different. For example, wave sources 512 can provide the same or different types of mechanical waves 514 (e.g., sound or vibration). As another example, wave sources 512 can provide waves having the same or different properties (e.g., speed, amplitude, frequency, wave form, energy, direction, or orientation). In some cases, enclosure 500 can include different wave sources 512 tuned or adjusted to provide waves with different properties (e.g., different frequency ranges or wave forms) that combine to provide a desired cleaning effect.

In some cases, the electronic device can control the manner in which several wave sources generate and emit individual waves to provide a specific impulse at a particular region of the outer component. In particular, the electronic device can define the waves emitted by the wave sources to provide a standing wave at a particular location on the device enclosure. For example, the electronic device can direct wave sources 512 to emit waves 514 such that they create an impulse at or near foreign particle 530.

The electronic device can determine where to direct a particular impulse using any suitable approach. In particular, the electronic device (or control circuitry thereof) can use any suitable approach to detect individual particles, and determine their positions. For example, the electronic device can analyze the manner in which light emitted by a display towards an optical component (e.g., a cover glass) reflects back into the device. As another example, the electronic device can detect and analyze a user's inputs provided to the device (e.g., detect individual touch inputs on a touch interface, or determine over time the most touched regions of the enclosure, such as buttons or particular areas of a touch interface). As still another example, the electronic device can receive or generate a historic or empirical collection of regions of a device enclosure at which a user touches the device, or where foreign particles adhere to the device and accumulate. As still yet another example, the electronic device can receive a user input identifying specific regions of the enclosure that are dirty.

In some embodiments, the electronic device can include a clean-up cycle or other routine to remove all foreign particles on the enclosure. When this cycle is activated, the electronic device can direct the wave sources to emit waves that create a series of impulses over the entirety of the enclosure, or over the entirety of a particular outer component. For example, the wave sources can emit several standing waves that propagate from one end to another end of an outer component. Foreign particles on the outer component can be directed towards the other end of the outer component, where they may be easily removed. The electronic device can initiate the clean-up cycle using any suitable approach. For example, a user can direct the device to initiate it. As another example, the electronic device can initiate the clean-up cycle at predetermined times or intervals (e.g., at times when the device is in use). As still another example, the electronic device can automatically initiate the clean-up cycle in response to determining that foreign particles are the device. If a clean-up cycle is scheduled for a time when the device is in use, the clean-up cycle can in some cases be delayed until a time when the device is no longer in use (e.g., to reduce an impact on a user).

In some embodiments, the electronic device can modify the properties of individual waves emitted by the wave sources based on the type of particle to remove, or on the bond between a particle and an outer component. For example, different types of waves (e.g., waves with different forms, frequencies, or amplitudes) may be optimized for removing different types of particles. In particular, different waves can be more effective for removing oil-based particles and water-based particles. Furthermore, different waves may more effective for different types of oil-based particles (e.g., human skin oils versus food oils). To tune a wave emitted by wave source for a particular particle, the electronic device can first identify characteristics of a particle adhered to the device, identify specific wave characteristics that correspond to the identified characteristics of the particle, and provide a tailored wave having the identified specific wave characteristics.

The electronic device can use any suitable approach to identify specific particles, or specific characteristics of particles adhered to an outer component. For example, the electronic device can examine a spectral response from a light source (e.g., a LED) providing light through a display. As another example, the electronic device can detect specific values of contact angles that are characteristic to specific types of particles. As still another example, the electronic device can determine a type of particle based on the environment in which the device is placed (e.g., held by a user or standing in a dock) or on the time of day (e.g., particles detected during or after a typical meal time may more likely be oil-base particles rather than water-based particles).

Once the contact angle of a particle adhered to an outer component has been increased, different approaches can used to removed the particle from the outer component. In some cases, a user can simply wipe the outer component. The large contact angle can ensure that the particle is removed from the outer component when it is wiped. Alternatively, placing or removing the device from a pocket or bag may generate sufficient contact between the outer component and the pocket or bag to remove the particle.

In some cases, waves emitted by the wave sources can be controlled to direct foreign particles to move in a particular manner. For example, waves emitted by several wave sources can constructively and destructively combine to provide a force directing a particle along a particular path on the outer component. The waves can be provided such that the waves form a three-dimensional structure (e.g., a gully, canyon, or walled enclosure) into which the particle is directed and guided. The waves can change dynamically based on a detected position of the particle, such that the path of a particle can be changed as necessary (e.g., make the particle turn on the surface of the outer component). In some cases, the waves can be controlled to change the speed at which a particle moves (e.g., by adjusting the manner in which a closed end of a gully moves towards an open end of a gully, thus pushing the particle).

The waves can direct particles towards any suitable region of the enclosure. In some cases, particles can be directed towards regions of the enclosure where the particles are less noticeable (e.g., away from the center of the outer component). In some cases, particles can be directed towards a region of the enclosure that is easily cleaned (e.g., towards an edge of an outer component, or towards an interface between several outer components). For examples, particles can be directed towards angled regions of the enclosure where the enclosure is likely to come into contact with cloth, for example in a user's pocket or in a bag or case.

In some cases, the outer component can include one or more wicks or reservoirs for receiving and holding foreign particles. The mechanical waves generated by the wave sources can direct foreign particles towards the wicks and/or reservoirs, where the particles may collect and be removed. For example, as shown in FIG. 4, waves 514 can direct particle 510 towards reservoir 520. By gathering foreign particles in a single location (e.g., a reservoir), cleaning the enclosure may be simplified. In particular, a user may need to clean only the region of the enclosure or outer component that includes the reservoir.

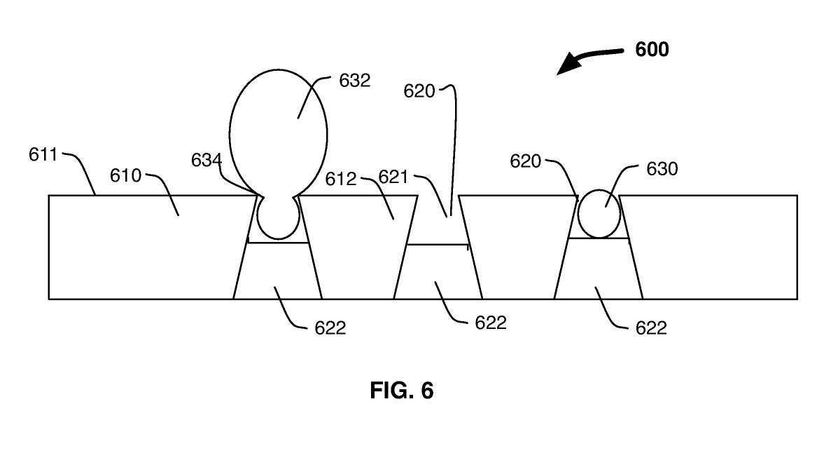

The reservoir can be constructed using any suitable approach. In particular, the reservoir may need to be constructed such that it may receive and accumulate foreign particles, but also allow the foreign particles to be removed when the enclosure is cleaned. On approach may be to use micro-perforations to form the reservoir. FIG. 6 is a sectional view of an illustrative reservoir for receiving foreign particles in accordance with some embodiments of the invention. Device 600 can include outer component 610 having reservoir 612. Reservoir 612 can include several micro-perforations 620 disposed within outer component 610. Reservoir 612 can include any suitable number of micro-perforations disposed in any suitable manner. The number of micro-perforations provided can be selected, for example, based on the desired size for reservoir 612 (e.g., the number of foreign particles to receive before the reservoir is full). The micro-perforations can be disposed in any suitable pattern, and at any suitable density. For example, micro-perforations 620 can be distributed close enough to each other so that reservoir 612 is relatively small, but spaced far apart enough from each other that foreign particles received in each micro-perforation do not adhere to other foreign particles in adjacent micro-perforations and form a stronger bond with outer component 610. In some cases, a regular pattern can be selected for micro-perforations 620 to maintain a minimum spacing between micro-perforations.

Each micro-perforation 612 can have any suitable diameter or size, such as a size that is not visible to a user's naked eye. Each micro-perforation 620 can include open region 621 exposed to external surface 611 of outer component 610, and filled region 622 preventing contaminants from passing through the micro-perforation and into the device. When particle 630 is directed towards micro-perforations 620, some or all of particle 630 can fall within one or more open regions 621. When another particle reaches the micro-perforations, the particle can adhere to a particle previously enclosed within open region 621 such that the resulting particle 632 has a thin neck 634. As more particles reach reservoir 612, the particles can adhere to other particles located within an open region 621, or to other particles already extending from a micro-perforation (e.g., adhere to particle 632).

To empty reservoir 612, a user can wipe over the reservoir, which will cause the particles in reservoir 612 to break (e.g., at neck 634) and be removed from outer component 610. In some cases, a further wiping action can be used to remove the particles remaining within open regions 621. To assist in the removal of particles from reservoir 612, one or more wave sources can generate waves that are directed at micro-perforations 620. The waves can cause individual particles to be break (e.g., at neck 634), or to be expelled from micro-perforations 620 (e.g., expelled from open regions 621).

In some cases, instead of directing foreign particles towards a particular region of an enclosure for removal, the waves generated by the wave sources can be used to break up foreign particles that are adhered to the outer component to create a thin, non-visible layer of foreign particles on the outer component. Using this approach, the electronic device can direct the wave sources to emit waves having specific characteristics that correspond to different foreign particle sizes, were each wave is selected to break down a particular foreign particle to a smaller size. In addition, the emitted waves can direct specific particles to different regions of the outer component to form a uniform layer. When the foreign particles create a coating layer that exceeds a threshold amount (e.g., it becomes visible to a user, or waves emitted by the wave sources can no longer break down particles), the entire coating can be removed. For example, the device can direct a user to wipe away the coating, or the device can emit waves to direct the entire coating towards a reservoir.

The active barrier process (e.g., the activation of wave sources to generate mechanical waves) provided in the electronic device can be implemented at any suitable time. In some embodiments, a user can direct the electronic device to implement the active barrier process. For example, the user can provide a corresponding instruction using an input interface. In some embodiments, the electronic device can instead or in addition automatically implement the active barrier process (e.g., generate mechanical waves). For example, the device can implement the active barrier process when the user touches the device, or when a foreign particle is detected on an outer component. As another example, the electronic device can implement the active barrier process as a clean-up cycle (e.g., cycle through a number of waveforms over different regions of the device enclosure to clean the entire device), as discussed above. As still another example, the active barrier process can be implemented based on the device use (e.g., implement the process when the user is or is not using the device), expected cleanliness of the device (e.g., implement after 30 minutes of device use), when an accessory is detected (e.g., implement when the device is in a dock), when the device is in a particular location (e.g., the device is in a user's pocket, or in the user's office), based on power management considerations, or combinations of these.

In some cases, the wave source used for foreign particle removal can be incorporated in an existing component of the device (e.g., a component having another primary or secondary function). For example, an audio-based wave source can be incorporated in a speaker component of the device. As another example, a piezo-electric component-based wave source can be incorporated in a haptic feedback component of the device. In some cases, the wave source may have such power requirements or output capabilities that other device components can instead or in addition be incorporated in the wave source components.

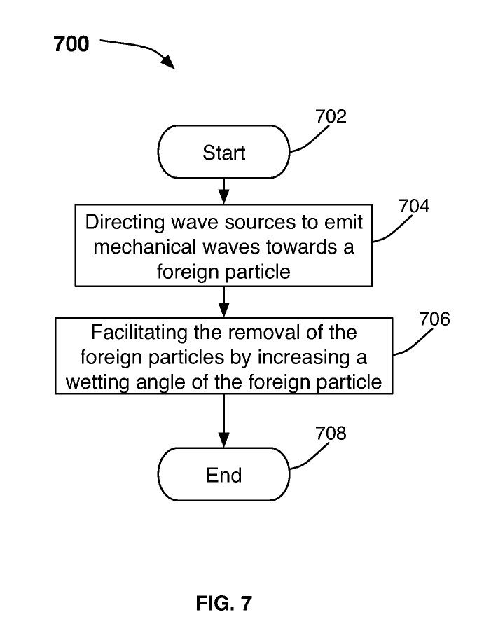

The following flowcharts describe illustrative processes used to remove foreign particles from outer components of an electronic device. FIG. 7 is a flowchart of an illustrative process for removing foreign particles adhered to an outer component of a device in accordance with some embodiments of the invention. Process 700 can begin at step 702. At step 704, several wave sources incorporated within the device can be directed to emit mechanical waves. The waves can be oriented or directed towards a particular location on a surface of an outer component, for example towards a location at which a foreign particle is adhered to the outer component. At step 706, the removal of the foreign particle from the device surface can be facilitated. For example, the mechanical waves can cause the contact angle of the foreign particle on the outer component to increase. Process 700 can then end at step 708.

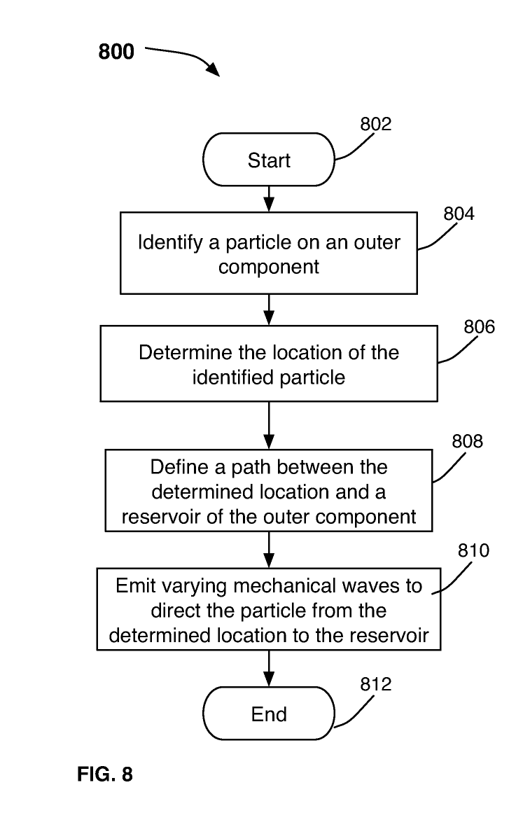

FIG. 8 is a flowchart of an illustrative process for directing a foreign particle towards a reservoir in accordance with some embodiments of the invention. Process 800 can begin at step 802. At step 804, a particle can be identified on an outer component. For example, an electronic device can detect that a foreign particle has adhered to a surface of an outer component. At step 806, the location of the identified particle can be determined. For example, the device can identify a particular location relative to an input interface (e.g., relative to a touchscreen) to which a particle has adhered. At step 808, a path can be defined between the determined location and a reservoir of the outer component. For example, the device can define a path between the location and an edge of the outer component where a reservoir for receiving foreign particles is located. At step 810, varying mechanical waves can be emitted to direct the particle from the determined location to the reservoir. For example, one or more wave sources can emit mechanical waves having the same or different characteristics such that each wave provides a pulse aimed at the particle for directing the particle towards the reservoir. Process 800 can then end at step 812.

It is to be understood that the steps shown in each one of processes 700 and 800 of FIGS. 7 and 8, respectively, are merely illustrative and that existing steps may be modified or omitted, additional steps may be added, and the order of certain steps may be altered.

Moreover, the processes described with respect to FIGS. 7 and 8, as well as any other aspects of the invention, may each be implemented in hardware or a combination of hardware and software. Embodiments of the invention can also be embodied as computer-readable code on a computer-readable medium. The computer-readable medium may be any data storage device that can store data which can thereafter be read by a computer system. Examples of the computer-readable medium include read-only memory (“ROM”), random-access memory (“RAM”), CD-ROMs, DVDs, magnetic tape, and optical data storage devices. The computer-readable medium can also be distributed over network-coupled computer systems so that the computer-readable code may be stored and executed in a distributed fashion.

Although many of the embodiments of the present invention are described herein with respect to personal computing devices, it should be understood that the present invention is not limited to such devices, but is generally applicable to other devices or components.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The above described embodiments of the present invention are presented for purposes of illustration and not of limitation, and the present invention is limited only by the claims which follow.

What is claimed is:

1. A method for removing a foreign particle adhered to an outer component of a device, comprising:
directing at least one wave source incorporated within the device to emit a mechanical wave towards a location of at least one foreign particle adhered to a surface of the outer component; and
facilitating the removal of the at least one foreign particle from the surface by increasing a wetting angle between the at least one foreign particle and the surface of the outer component via the mechanical wave.

2. The method of claim 1, further comprising:
detecting that the at least one foreign particle is wetted to a surface of the component.

3. The method of claim 2, further comprising
identifying at least one characteristic of the at least one foreign particle; and
tuning the mechanical wave based on the identified characteristics.

4. The method of claim 3, wherein tuning further comprises adjusting, for the mechanical wave, at least one of:
amplitude;
frequency;
waveform;
energy; and
orientation.

5. The method of claim 1, further comprising:
detecting the location of the at least one foreign particle on the surface of the outer component.

6. The method of claim 5, further comprising:
directing the at least one wave source to emit a varying mechanical wave operative to move the at least one foreign particle from the location.

7. The method of claim 6, wherein:
the varying mechanical wave is operative to move the at least one foreign particle towards a reservoir.

8. An electronic device, comprising:
an enclosure comprising at least one outer component having an external surface; and
a wave source placed adjacent to the outer component and operative to emit waves, wherein waves emitted by the wave source propagate to the external surface of the outer member where a foreign particle is adhered to the outer member to increase a wetting angle of the foreign particle with the external surface.

9. The electronic device of claim 8, further comprising:
control circuitry operative to control the operation of the wave source.

10. The electronic device of claim 9, wherein the control circuitry is further operative to:
detect the location of the foreign particle on the outer member; and
direct the wave source to emit a wave targeted at the detected location.

11. The electronic device of claim 10, wherein the control circuitry is further operative to:
direct the wave source to emit a wave operative to move the foreign particle from the detected location towards an edge of the outer component.

12. The electronic device of claim 8, wherein:
the enclosure comprises a plurality of outer components defining a volume in which electronic device components are retained.

13. The electronic device of claim 8, further comprising:
a plurality of wave sources distributed adjacent to different portions of the outer component.

14. The electronic device of claim 13, wherein:
the plurality of wave sources are distributed adjacent to an inner surface of the outer component.

15. An electronic device comprising an active barrier for preventing the adhesion of foreign particles, the electronic device comprising:
an outer component comprising an external surface exposed to foreign particles and an inner surface opposite the external surface;
a wave source positioned adjacent to the inner surface of the outer member, wherein the wave source is operative to emit a wave that propagates along the external surface; and
a reservoir incorporated in the outer component, wherein the reservoir is operative to receive foreign particles adhered to the outer component.

16. The electronic device of claim 15, wherein:
the reservoir comprises a plurality of micro-perforations, wherein each micro-perforation is operative to receive at least one foreign particle.

17. The electronic device of claim 15, further comprising control circuitry operative to:
detect characteristics of a foreign particle wetted to the outer component; and
identify characteristics for a wave emitted by the wave source that correspond to the detected characteristics of the foreign particle.

18. The electronic device of claim 17, wherein the control circuitry is further operative to:
direct the wave source to emit a wave having the identified characteristics.

19. The electronic device of claim 15, wherein the outer component comprises at least one of:
a housing;
a bezel;
a band;
a screen; and
a display component.

20. The electronic device of claim 15, wherein the wave source further comprises at least one of:
an audio component; and
a haptic feedback component.
